(19) United States
(12) Patent Application Publication
(10) Pub. No.: US 2009/0206829 A1
(43) Pub. Date: Aug. 20, 2009

(54) SIGNAL PROCESSING DEVICE FOR SENSING DEVICE

(75) Inventors: Kazuhiro KAMIYA, Kariya-shi (JP); Takashi Hara, Ichinomiya-shi (JP); Hidefumi Koashi, Tokoname-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi (JP)

(21) Appl. No.: 12/369,413

(22) Filed: Feb. 11, 2009

(30) Foreign Application Priority Data
Feb. 14, 2008 (JP) 2008-033490

(51) Int. Cl. G01P 3/00

(52) U.S. Cl. 324/207.25

(57) ABSTRACT

A signal processing device includes an upper amplitude value estimating portion estimating an upper amplitude value based on a peak value of the detection signal and a predetermined median value of a preset range, a lower amplitude value estimating portion estimating a lower amplitude value based on the median value and a bottom value of the detection signal, an offset adjustment signal generating portion generating an offset adjustment signal for offset-adjusting the detection signal in a case where either one of the upper amplitude value or the lower amplitude value is set as a reference value and the other one of the upper and lower amplitude values becomes greater than a set value, an offset adjustment portion offset-adjusting the detection signal based on the offset adjustment signal, and a binarization portion binarizing an output signal from the offset adjustment portion based on a threshold value estimated from the detection signal.

### CROSS REFERENCE TO RELATED APPLICATIONS

This application is based on and claims priority under 35 U.S.C. § 119 to Japanese Patent Application 2008-033490, filed on Feb. 14, 2008, the entire contents of which is incorporated herein by reference.

### FIELD OF THE INVENTION

The present invention relates to a signal processing device for a sensing device/related to the sending device, which generates a binarized output signal on the basis of a detection signal inputted from a sensing device and a threshold value estimated from the detection signal.

### BACKGROUND

A rotation detecting sensor is used as a known method of detecting a rotational speed of rotating equipment. The rotation detecting sensor detects changes of magnetic flux or magnetic field occurring at a detecting surface of a detecting element, which configures the rotation detecting sensor, in response to a rotation of a rotating body, which structures the rotating equipment. In other words, the detecting element detects the changes of the magnetic flux or the magnetic field and converts the detected changes into an electric signal whose amplitude changes with time in response to the rotation of the rotating body. The electric signal finally is converted as a binarized signal by a processing means/processing circuits included in a sensor signal processing device. Then, the period of the binarized pulse corresponds to the rotational speed of the rotating body.

As an application of the above-described rotation detecting sensor, the rotation detecting sensor is adapted to detect a rotational speed of a rotating body of the vehicle (e.g. an axle, a motor and the like). The vehicle may bound depending on a driving state, a condition of a road surface and the like. Therefore, even if the rotating body does not rotate, changes with time may occur in a distance between the rotating body and the detecting element because of the above-mentioned bound generated at the vehicle. Accordingly, the rotation detecting sensor may accidentally generate an output signal when changes in the magnetic flux occur in response to such distance changes. Further, not only because of the bound, but also an erroneous error may be included in the output signal because of a spike noise synchronized with an output of another oscillator and the like provided close to the rotation detecting sensor. Disclosed in JP3326933B is a signal processing device for a sensing device/related to a sensing device that is configured to reduce an influence of such spike noise.

The signal processing device for a sensing device/related to the sensing device disclosed in JP3326933B detects changes of magnetic field in response to the rotation of the rotating body and sets a threshold value on the basis of a peak value and a bottom value of the detected signal. Then, as illustrated in FIG. 1, the detected signal (a solid line) and the threshold value (a dotted line) are inputted into a comparator, and a final binarized signal is generated. Further, the signal processing device disclosed in JP3326933B executes an offset adjustment in a sensor signal processing only when the detection signal exceeds any desired upper limit value or lower limit value.

In the sensor signal processing device disclosed in JP3326933B, the threshold value used for binarization of the detection signal is set as follows. In a case where the binarized output signal is “High”, the threshold value is set as follows: threshold value=((peak value)−(bottom value))*(¼). On the other hand, in a case where the binarized output signal is “Low”, the threshold value is set as follows: threshold value=((peak value)−(bottom value))*(¾). The binarized output signal is generated on the basis of the threshold value, which is set as above, and the detected signal. The detected signal of the rotation detecting sensor may drift by temperature changes in response to changes of ambient temperature (i.e. a temperature drift may occur in the rotation detecting sensor/signal processing device). In this case, the following drawbacks may occur. The output signal from the sensor signal processing device disclosed in JP3326933B is illustrated in FIG. 2. In a condition I of FIG. 2, the rotating body rotates and the final binarized output signal (a pulse signal) is appropriately outputted on the basis of the detection signal and the threshold value. Then, for example, the detection signal drifts by temperature due to the changes of the ambient temperature changes (the temperature drift occurs in the rotation detecting sensor/the signal processing device) while the rotating member does not rotate as indicated in a condition II. Then, even if the rotating body rotates and the detection signal is obtained as illustrated in condition III after the condition II, the final binarized output signal in response to the changes with time of the detection signal is not outputted because the detection signal does not exceed the threshold value. In other words, a pulse skipping occurs in the final binarized output signal.

A need thus exists to provide a processing device for a sensing device/related to the sensing device which is not susceptible to the drawback mentioned above.

### SUMMARY OF THE INVENTION

According to an aspect of the present invention, a signal processing device for a sensing device/related to the sensing device, generating a final binarized output signal on the basis of a detection signal inputted from the sensing device and a threshold value estimated from the detection signal, includes an upper amplitude value estimating portion for estimating an upper amplitude value on the basis of a peak value of the detection signal and a predetermined median value of a preset range, a lower amplitude value estimating portion for estimating a lower amplitude value on the basis of the median value and a bottom value of the detection signal, an offset adjustment signal generating portion for generating an offset adjustment signal for executing an offset adjustment of the detection signal in a case where either one of the upper amplitude value or the lower amplitude value is set as a reference value in response to the output signal and the other one of the upper amplitude value and the lower amplitude value becomes greater than a set value defined on the basis of the reference value, an offset adjustment portion for offset adjusting the detection signal on the basis of the offset adjustment signal inputted from the offset adjustment signal generating portion, and a binarization portion for binarizing an output signal from the offset adjustment portion on the basis of the threshold value estimated from the detection signal.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a view illustrating an output signal generated on the basis of a detection signal and a threshold value n a known art;

FIG. 2 is a view illustrating the output signal in a case where the detection signal of the known art drifts;

FIG. 3 is a view schematically illustrating a sensor signal processing device according to an embodiment;

FIG. 4 is a view illustrating a relationship between a detection signal and specific ranges of a detection signal;

FIG. 5 is a view illustrating an offset adjustment in a case where the detection signal drifts towards a direction in which the detection signal increases when a rotating body stops rotating;

FIG. 6 is a view illustrating an offset adjustment in a case where the detection signal drifts in a direction in which the detection signal decreases when the rotating boy stops rotating;

FIG. 7 is a view illustrating an offset adjustment in a case where the rotating body has just started and after a predetermined time has passed since the rotating body has started; and

FIGS. 8A and 8B are views illustrating a digital conversion of the detection signal.

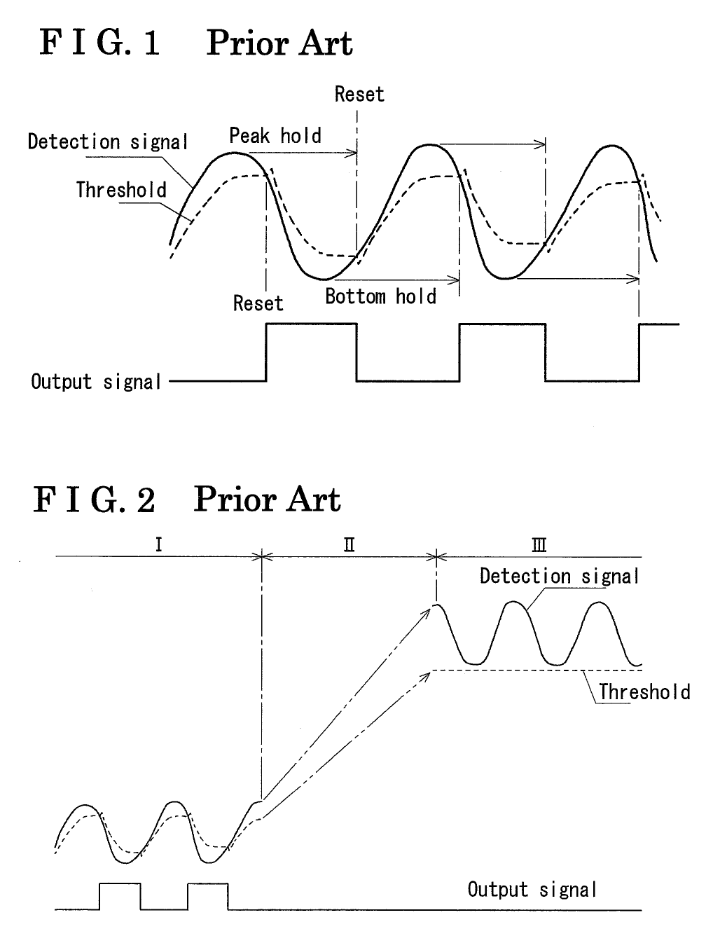

### DETAILED DESCRIPTION

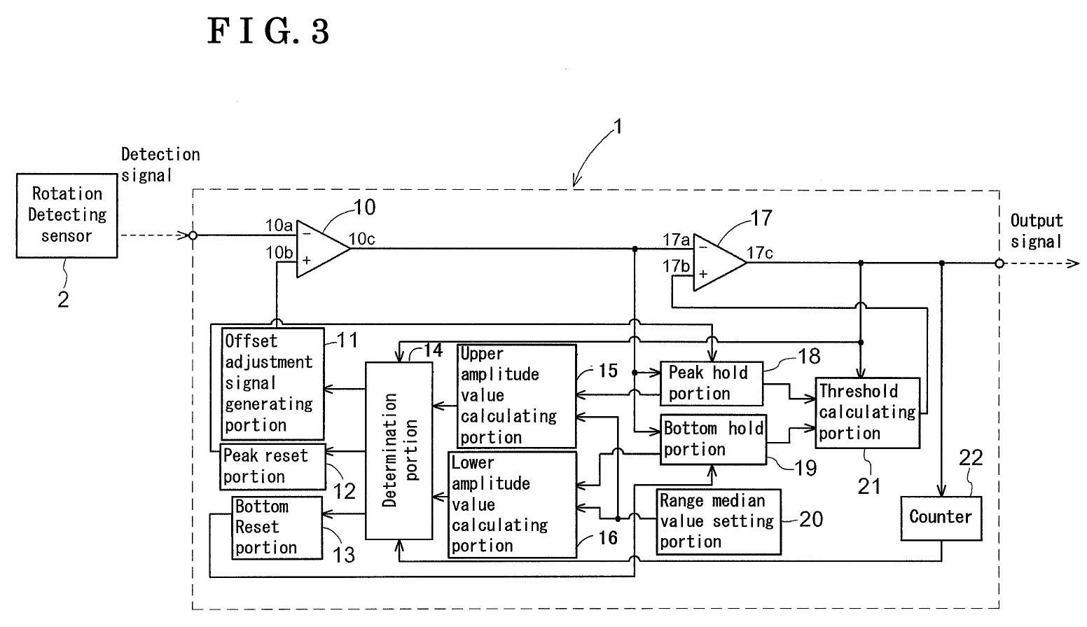

Embodiments of a signal processing device for a sensing device/related to the sensing device will be described below with reference to the attached drawings. A sensor signal processing device 1 is schematically illustrated in FIG. 3. The sensor signal processing device 1 generates a final binarized output signal on the basis of a detection signal, which is inputted from a rotation detecting device 2 provided at an early stage of the sensor signal processing device 1 and detecting a rotation of a rotating body, and a threshold value Vth, which is estimated from the detection signal. Additionally, the sensor signal processing device 1 includes a function of executing an offset adjustment on the basis of the detection signal in a case where the detection signal increases or decreases (drifts) due to changes of ambient temperature and the like. The detailed description of the sensor signal processing device 1 will be given below.

The sensor signal processing device 1 is configured with functional portions such as a first estimating portion 10, an offset adjustment signal generating portion 11, a peak reset portion 12, a bottom reset portion 13, a determination portion 14, an upper amplitude value estimating portion 15, a lower amplitude value estimating portion 16, a second estimating portion 17, a peak hold portion 18, a bottom hold portion 19, a range median value setting portion 20, a threshold value estimating portion 21 and a counter 22. The sensor signal processing device 1 is configured so that the functional portions for executing various processes relating to a sensor signal processing with a central processing unit (CPU) as a core member are built with either one of or both of a hardware and a software. Each portion of the sensor signal processing device 1 will be described below.

The first estimating portion 10 serves as an offset adjustment means (an offset adjustment portion) for executing the offset adjustment of the detection signal. The first estimating portion 10 may be preferably configured with an operational amplifier so as to prepare an inverting terminal 10a, a non-inverting terminal 10b and an output terminal 10c. The detection signal inputted into the sensor signal processing device 1 as an output of the rotation detecting device 2 is inputted into the inverting terminal 10a. The detection signal is an output signal of the rotation detecting device 2, which is provided at the early stage of the sensor signal processing device 1. Therefore, the detection signal indicates a sine wave in which magnetic flux or magnetic field changes with time in response to a rotational speed of the rotating body detected by the rotation detecting device 2.

An offset adjustment signal, which is generated by the offset adjustment signal generating portion 11, is inputted into the non-inverting terminal 10b. The offset adjustment signal is used for offsetting a drift in the case where the detection signal from the rotation detecting device 2 drifts due to the changes of the ambient temperature and the like. The first estimating portion 10 transmits an estimated result based on the detection signal and the offset adjustment signal as an output signal to the second estimating portion 17, the peak hold portion 18 and the bottom hold portion 19 from the output terminal 10c. Additionally, the detection signal is outputted without being adjusted as the output signal of the first estimating portion 10 in a case where the function portion included in the sensor signal processing device 1 determines that the offset adjustment does not need to be executed to the detection signal of the rotation detecting device 2. In other words, the output signal from the offset adjustment signal generating portion 11 indicates the above-mentioned sine wave. On the other hand, in a case where the functional portion included in the sensor signal processing device 1 determines that the offset adjustment is necessary, the offset adjustment is executed to the detection signal and the adjusted detection signal is outputted. Hence, the output signal outputted from the offset adjustment signal generating portion 11 in this case also indicates the sine wave.

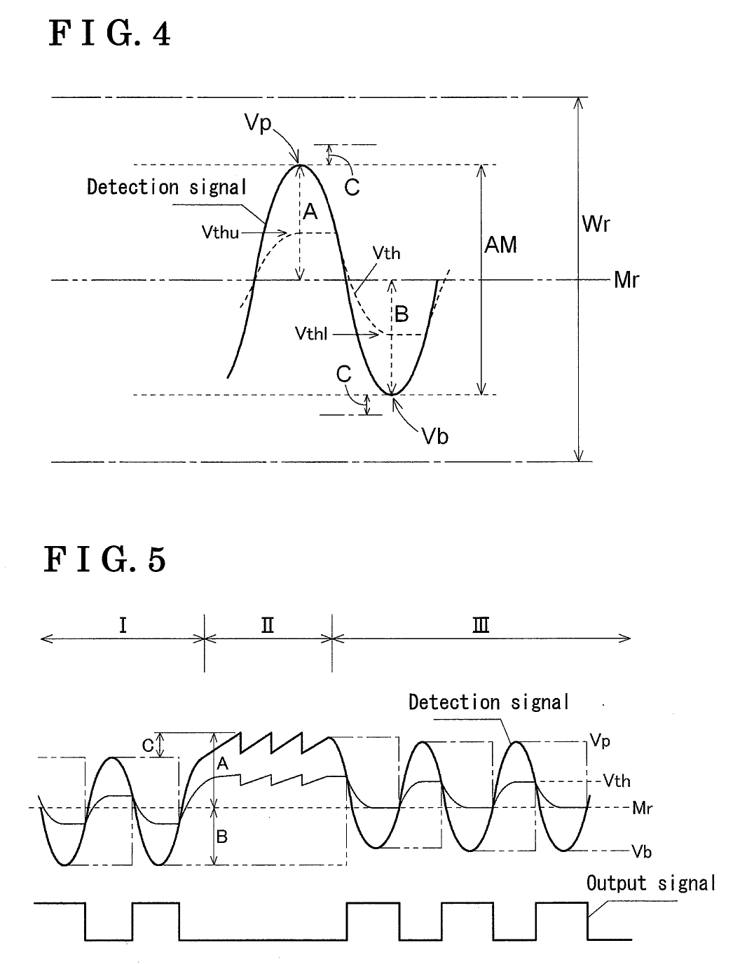

The peak hold portion 18 is configured with a so-called peak hold circuit. The peak hold portion 18 detects a peak value Vp of the signal inputted into the peak hold portion 18. The peak hold circuit may be preferably configured with a capacitor, a diode, an operational amplifier and the like. As the known peak hold circuit is adapted to the peak hold portion 18, the detailed explanation of the peak hold circuit is omitted here. The peak value Vp is a value at which a wave form of the signal illustrated in FIG. 4 reaches the highest point. Accordingly, in this embodiment, the peak hold portion 18 detects the peak value Vp of the output signal (the sine wave) from the first estimating portion 10. The peak value Vp is transmitted to the upper amplitude value estimating portion 15 and the threshold value estimating portion 21.

The bottom hold portion 19 is configured with a so-called bottom hold circuit. The bottom hold portion 19 detects a bottom value Vb of the signal inputted into the bottom hold portion 19. The bottom hold circuit may be preferably configured with a capacitor, a diode, an operational amplifier and the like. As the known bottom hold circuit is adapted to the bottom hold portion 19, the detailed explanation of the bottom hold circuit is omitted here. The bottom value Vb is a value at which the wave form of the signal illustrated in FIG. 4 reaches the lowest point. Accordingly, in this embodiment, the bottom hold portion 19 detects the bottom value Vb of the output signal (the sine wave) from the first estimating portion 10. The bottom value Vb is transmitted to the lower amplitude value estimating portion 16 and the threshold value estimating portion 21.

The sensor signal processing device 1 will be further described with reference to FIG. 3. The range median value setting portion 20 sets a median value of a range Wr (which will be hereinafter referred to as a range median value Mr) in response to an amplitude of the detection signal inputted from the rotation detecting device 2. The range Wr is preliminarily set so as to be greater than an amplitude AM of the detection signal in a case where the rotation detecting device 2 is steadily operated (i.e. in a state where the temperature drift and the like do not occur) as illustrated in FIG. 4, depending on the structure, a rating and the like of the sensor signal processing device 1. The range median value setting portion 20 sets a value corresponding to a half of the range Wr as the range median value Mr in response to the set range Wr.

The upper amplitude value estimating portion 15 estimates an upper amplitude value A on the basis of the peak value Vp of the detection signal and the range median value Mr of the pre-set range Wr. The peak value Vp is transmitted to the upper amplitude value estimating portion 15 from the peak hold portion 18, and the range median value Mr is transmitted to the upper amplitude value estimating portion 15 from the range median value setting portion 20. The upper amplitude value A is calculated by subtracting the range median value Mr from the peak value Vp of the detection signal, as illustrated in FIG. 4. For example, in a case where the sensor signal processing device 1 is configured so as to update the peak value Vp every predetermined time, an amplitude value of when an amplitude at an upper side more than the range median value Mr in the predetermined time reaches a peak is set as the upper amplitude value A.

The lower amplitude value estimating portion 16 estimates a lower amplitude value B on the basis of the range median value Mr and the bottom value Vb of the detection signal. The bottom value Vb is transmitted to the lower amplitude value estimating portion 16 from the bottom hold portion 19, and the range median value Mr is transmitted to the lower amplitude value estimating portion 16 from the range median value setting portion 20. The lower amplitude value B is calculated by subtracting the bottom value Vb from the range median value Mr of the detection sensor, as illustrated in FIG. 4. For example, in a case where the sensor signal processing device 1 is configured so as to update the bottom value Vb every predetermined time, an amplitude value of when an amplitude at a lower side less than the range median value Mr in the predetermined time reaches a bottom peak is set as the lower amplitude value B.

The second estimating portion 17 serves as a binarization means (binarization portion) for binarizing the output signal from the first estimating portion 10 on the basis of the threshold value Vth, which is estimated by the threshold value estimating portion 21. The signal binarized by the second estimating portion 17 serves as an output signal of the sensor signal processing device 1. The binarization is a process of converting an analogue signal such as the sine wave into binary signal such as a High level and Low level. Hence, the second estimating portion 17 may be preferably configured with, for example, a comparator. In this case, the output signal (the sine wave) of the first estimating portion 10 is inputted into an inverting terminal 17a of the second estimating portion 17, and the threshold value Vth from the threshold value estimating portion 21 is inputted into a non-inverting terminal 17b of the second estimating portion 17. Accordingly, a pulse signal, which is binarized on the basis of the sine wave and the threshold value Vth, is outputted from an output terminal 17c of the second estimating portion 17.

The threshold value estimating portion 21 estimates the threshold value Vth used for the conversion of binarizing the sine wave, outputted from the first estimating portion 10, as the pulse signal by the second estimating portion 17. As illustrated in FIG. 4, the threshold value Vth is set to exist between the peak value Vp and the range median value Mr in a case where the detection signal oscillates above the range median value Mr. On the other hand, in a case where the detection signal oscillates below the range median value Mr, the threshold value Vth is set to exist between the range median value Mr and the bottom value Vb. Accordingly, the threshold value Vth includes an upper threshold value Vthu and a lower threshold value Vthl depending on an amplitude state of the detection signal. As illustrated in FIG. 4, switching between the upper threshold value Vthu and the lower threshold value Vthl is executed when the detection signal falls below the threshold value Vth and when the detection signal exceeds the threshold value Vth. The threshold value Vth is indicated by a like saturation curve having a predetermined time constant until the threshold value Vth shifts either to the upper threshold value Vthu or to the lower threshold value Vthl from the other one of the upper threshold value Vthu and the lower threshold value Vthl. More concretely, the threshold value value Vth (the upper threshold value Vthu and the lower threshold value Vthl) is calculated as follows (equation 1 and equation 2).

$$\begin{matrix}Vthu = ( Vp - Vb ) \cdot \frac{3}{4} & Equation 1 \\ Vthl = ( Vp - Vb ) \cdot \frac{1}{4} & Equation 2\end{matrix}$$

where Vthu indicates the upper threshold value, Vthl indicates the lower threshold value, Vp indicates the peak value and the Vb indicates the bottom value.

The determination portion 14 sets either one of the upper amplitude value A or the lower amplitude value B as a reference value. Then, the determination portion 14 determines whether or not the other one of the upper amplitude value A and the lower amplitude value B is greater than the set value determined by the reference value (see FIG. 4). The upper amplitude value A is transmitted to the determination portion 14 from the upper amplitude value estimating portion 15, and the lower amplitude value B is transmitted to the determination portion 14 from the lower amplitude value estimating portion 16. The reference value is determined in response to the output signal of the sensor signal processing device 1. In other words, in a case where the output signal is in the Low level, the lower amplitude value B is used as the reference value. On the other hand, in a case where the output signal is in the High level, the upper amplitude value A is used as the reference value. Further, the set value is defined by a sum of the lower amplitude value B and a constant value C in the case where the output signal is in the Low level. On the other hand, the set value is defined by a sum of the upper amplitude value A and the constant value C in the case where the output signal is in the High level. Hence, in the case where the output signal is in the Low level, the determination portion 14 sets the lower amplitude value B as the reference value and determines whether or not a relationship “upper amplitude value A>lower amplitude value B+constant value C” is satisfied. On the other hand, in the case where the output signal is in the High level, the determination portion 14 sets the upper amplitude value A as the reference value and determines whether or not a relationship “lower amplitude value B>upper amplitude value A+constant value C” is satisfied.

The known sensor signal processing device is configured so as to clamp the detection signal to stay within the range Wr when the peak value Vp or the bottom value Vb of the detection signal reaches an upper limit or a lower limit of the range Wr, respectively, because of a characteristic of the sensor signal processing device. However, if the detection signal is clamped, a waveform of the detection signal may change because, specifically, the peak value Vp and the bottom value Vb are cut. In this case, the output signal is generated on the basis of the detection signal in which the peak value Vp and the bottom value Vb are cut. Accordingly, an accurate output signal may not be obtained. Hence, the sensor signal processing device 1 of the embodiment includes the function of executing the offset adjustment to the detection signal so that the detection signal is not clamped and so that the waveform of the detection signal does not change even if the detection signal drifts due to the changes of the ambient temperature and the like.

The constant value C used for the determination executed by the determination portion 14 corresponds to an offset adjustment threshold value, which is used for determining whether or not to execute the offset adjustment in the case where the detection signal drifts. As illustrated in FIG. 4, the constant value C may be preferably set to a value less than a half of a difference between the range Wr and the peak-to-peak amplitude value AM of the detection signal. More concretely, for example, in a case where the range Wr is 2V and the peak-to-peak amplitude value AM of the detection signal is 1.8V, the constant value C is preferably set to a value less than a half of 0.2V, which is a difference between the range Wr and the peak-to-peak amplitude value AM of the detection signal, i.e. the constant value C is preferably set to a value less than 0.1V. More specifically, it may be preferable if the constant value C is set to, for example, a few ten mV. Accordingly, the determination portion 14 determines whether or not the upper amplitude value A is greater than the set value, which is defined on the basis of the lower amplitude value B (i.e. lower amplitude value B+constant value C). Alternatively, the determination portion 14 determines whether or not the lower amplitude value B is greater than the set value, which is defined on the basis of the upper amplitude value A (i.e. upper amplitude value A+constant value C). The determination result is transmitted to the offset adjustment signal generating portion 11.

Further, the determination portion 14 receives the output signal of the threshold value estimating portion 21 and executes a determination of rise time and fall time of the binarized output signal. The term “rise time” indicates that the binarized output signal turns from the Low level to the High level. On the other hand, the term “fall time” indicates that the binarized output signal turns from the High level to the Low level. The Low level of the output signal is not limited to a level corresponding to a position where the signal is zero per cent (0%), but the Low level of the output signal may be determined at any desired positions (e.g. a level corresponding to a position where the signal is ten per cents (10%)). Similarly, the High level of the output signal is not limited to a level corresponding to a position where the signal is a hundred per cent (100%), but the High level of the output signal may be determined at any desired positions (e.g. a level corresponding to a position where the signal is ninety per cents (90%)). The determination result is transmitted to the peak reset portion 12 and to the bottom reset portion 13.

The offset adjustment signal generating portion 11 generates the offset adjustment signal for offset-adjusting the detection signal on the basis of the upper amplitude value A and the lower amplitude value B. In other words, the detection signal is offset-adjusted on the basis of the determination result, which is obtained by the determination portion 14 by using the upper amplitude value A, the lower amplitude value B and the constant value C. More specifically, in the case where the determination portion 14 determines that the upper amplitude value A is greater than the set value, which is defined on the basis of the lower amplitude value B (i.e. lower amplitude value B+constant value C), when the output signal is in the Low level, the offset adjustment signal generating portion 11 outputs the offset adjustment signal, which reduces the upper amplitude value A by the constant value C, to the non-inverting terminal 10b of the first estimating portion 10. On the other hand, in the case where the determination portion 14 determines that the upper amplitude value A is not greater than the set value, which is defined on the basis of the lower amplitude value B (i.e. lower amplitude value B+constant value C), the offset adjustment signal for offset-adjusting the detection signal is not outputted. In this case, the offset adjustment signal generating portion 11 may be configured so as to output a signal indicating that the offset adjustment is not to be executed.

Further, in the case where the determination portion 14 determines that the lower amplitude value B is greater than the set value, which is defined on the basis of the upper amplitude value A (i.e. upper amplitude value A+constant value C), when the output signal is in the High level, the offset adjustment signal generating portion 11 outputs the offset adjustment signal, which reduces the lower amplitude value B by the constant value C, to the non-inverting terminal 10b of the first estimating portion 10. On the other hand, in the case where the determination portion 14 determines that the lower amplitude value B is not greater than the set value, which is defined on the basis of the upper amplitude value A (i.e. upper amplitude value A+constant value C), the offset adjustment signal for offset-adjusting the detection signal is not outputted. In this case, the offset adjustment signal generating portion 11 may be configured so as to output the signal indicating that the offset adjustment is not to be executed.

The peak reset portion 12 resets the peak value Vp of the detection signal detected by the peak hold portion 18. The peak reset portion 12 resets the peak value Vp of the detection signal in response to the determination result of the rise time and fall time of the output signal executed by the determination portion 14. In a case where the determination portion 14 determines that the output signal falls, the peak reset portion 12 resets the peak value Vp detected by the peak hold portion 18. In the case where the peak value Vp is reset as described above, the peak hold portion 18 re-detects the peak value Vp.

The bottom reset portion 13 resets the bottom value Vb of the detection signal detected by the bottom hold portion 19. The bottom reset portion 13 resets the bottom value Vb of the detection signal in response to the determination result of the rise time and fall time of the output signal executed by the determination portion 14. In a case where the determination portion 14 determines that the output signal rises, the bottom reset portion 13 resets the bottom value Vb detected by the bottom hold portion 19. Further, in the case where the bottom value Vb is reset, the bottom hold portion 18 re-detects the bottom value Vb.

The counter 22 counts the number of pulses included in the output signal of the sensor signal processing device 1. The count is started at the same timing as when the sensor signal processing device 1 is started. Further, the count is reset at the same timing as when exiting the sensor signal processing device 1. The count result of the counter 22 is transmitted to the determination portion 14.

The number of pulses included in the output signal being few (e.g., the number of pulses include in the output signal being less than ten) indicates that the sensor signal processing device 1 has just started, and in this case, the detection signal may not be properly obtained. In other words, in an initial operation of the sensor signal processing device 1, the accurate peak value Vp and the bottom value Vb are not obtained unless at least one cycle of the detection signal is obtained, because it is indistinguishable from which position the waveform of the detection signal starts. Therefore, in the initial operation of the sensor signal processing device 1, a balance between the upper amplitude value A and the lower amplitude value B may be broken. If the set value is set to be lower in the above-mentioned state, unnecessary offset adjustment may be executed.

Hence, in order to prevent the unnecessary offset adjustment from being executed, it may be preferable that the determination portion 14 changes the set value, which is used for the determination, in response to the number of pulses included in the output signal. In this embodiment, the set value, in a case where the number of pulses counted by the counter 22 becomes equal to or greater than a preliminarily set number of pulses, is set to be lower than the set value in a case where the number of pulses counted by the counter 22 is less than the preliminarily set number of pulses.

More concretely, the constant value C is increased in order to increase the set value in the case where the number of pulses is few. On the other hand, the number of pulses being plenty (e.g. the number of pulses being equal to or more than ten) indicates that a certain time (a satisfactory time) has passed since the sensor signal processing device 1 has started, and therefore, the accurate peak value Vp and the bottom value Vb are obtained. Accordingly, the upper amplitude value A and the lower amplitude value B are accurately obtained. Hence, in this case, the constant value C is decreased in order to decrease the set value.

An example of the case where the offset adjustment is executed will be described below in accordance with the attached drawings. The offset adjustment in a case where the detection signal drifts towards a direction, in which the detection signal increases when the rotating body is stopped rotating, is illustrated in FIG. 5. Additionally, in FIG. 5, a lateral axis represents a time line. More specifically, time is indicated so as to flow from left to right in FIG. 5. In FIG. 5, a condition I indicates a state where the rotation detecting device 2 is normally operating before the offset adjustment is executed, a condition II indicates a state where the detection signal drifts when the rotating body is stopped rotating and the offset adjustment is being executed, and a condition III indicates a state where the rotating body is rotating after the offset adjustment is executed.

In the condition I, the rotation detecting device 2 stably detects the rotation of the rotating body, and the pulse signal is appropriately outputted as the output signal on the basis of the detection signal and the threshold value Vth, which is calculated from the detection signal. In other words, in the case where the threshold value Vth is greater than the detection signal, the rotation detecting device 2 outputs the detection signal in the High level as the output signal. On the other hand, in the case where the threshold value Vth is lower than the detection signal, the rotation detecting device 2 outputs the detection signal in the Low level as the output signal. Additionally, each of the peak value Vp and the bottom value Vb is reset in response to the rise time and fall time of the output signal.

As indicated in the condition II, in the case where the rotating body stops rotating and the detection signal drifts when the rotating body stops rotating, the sensor signal processing device 1 executes the offset adjustment to the detection signal. The offset adjustment is executed as follows. The output signal, the upper amplitude value A, the lower amplitude value B and the count result of the number of pulses by the counter 22 are transmitted to the determination portion 14. In the case where the determination portion 14 determines that the sensor signal processing device 1 stably operates because the number of pulses is plenty (e.g. the number of pulses is equal to or more than ten), the determination portion 14 sets the constant value C, used for the determination, to be lower (e.g. 20 mV). Then, the determination portion 14 sets the lower amplitude value B, which is currently held, as the reference value because the output signal is in the Low level.

In this state, the determination portion 14 determines whether or not the upper amplitude value A is greater than the set value, which is defined on the basis of the lower amplitude value B (i.e. lower amplitude value B+constant value C). In other words, the determination portion 14 determines whether or not the relationship “upper amplitude value A>lower amplitude value B+constant value C” is satisfied. Then, the determination portion 14 sends the determination result to the offset adjustment signal generating portion 11.

In the case where the determination result, which indicates that the relationship “upper amplitude value A>lower amplitude value B+constant value C” is satisfied, is transmitted to the offset adjustment signal generating portion 11 from the determination portion 14, the offset adjustment signal generating portion 11 outputs the offset adjustment signal for offset-adjusting the detection signal to the first estimating portion 10. The first estimating portion 10 offsets the detection signal by a predetermined amount on the basis of the offset adjustment signal in order to decrease the upper amplitude value A.

When the rotating body restarts rotating in the state where the detection signal is offset (i.e. when the condition turns to the condition III), the threshold value estimating portion 21 estimates the threshold value Vth on the basis of the peak value Vp, corresponding to the upper amplitude value A which has been decreased by the offset adjustment, and the bottom value Vb, corresponding to the lower amplitude value B, to which the offset adjustment is not executed. Then, the detection signal is binarized by the second estimating portion 17 on the basis of the threshold value Vth, and the second estimating portion 17 outputs the normal pulse signal as the output signal.

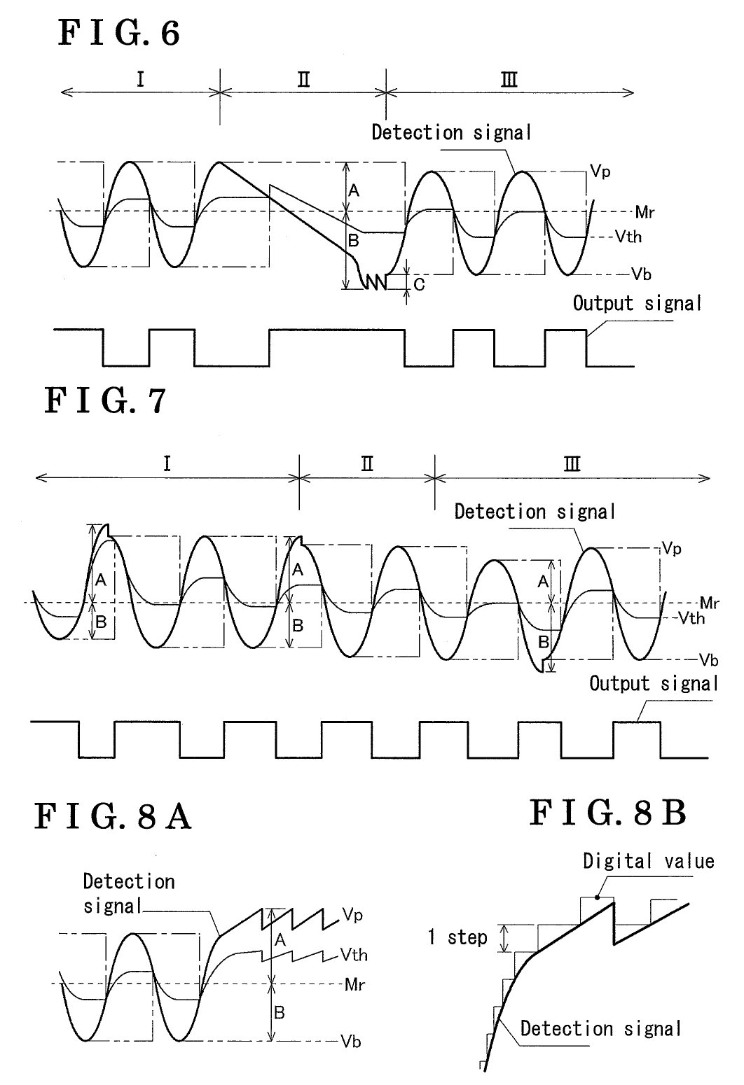

The offset adjustment in a case where the detection signal drifts towards a direction, in which the detection signal decreases, when the rotating body stops rotating will be described below in accordance with FIG. 6. As is the case with FIG. 5, a lateral axis represents a time line. More specifically, time is indicated so as to flow from left to right in FIG. 6. In FIG. 6, a condition I indicates a state where the rotation detecting device 2 is normally operating before the offset adjustment is executed, a condition II indicates a state where the detection signal drifts when the rotating body stops rotating and the offset adjustment is being executed, and a condition III indicates a state where the rotating body rotates after the offset adjustment is executed. Additionally, as is the case with the example illustrated in FIG. 5, described below is the offset adjustment in the case where the sensor signal processing device 1 in the normally operating state I does not indicate the state where the sensor signal processing device 1 has just started, but the condition I indicates the state where the sensor signal processing device 1 has been stably operated after a certain time has passed since the sensor signal processing device 1 has started, i.e. the case where the number of pulses counted by the counter 22 is plenty (e.g. the number of pulses is equal to or more than ten).

As is the case with FIG. 5, in the condition I, the pulse signal is rightly outputted as the output signal on the basis of the detection signal and the threshold value Vth, which is estimated from the detection signal. Further, each of the peak value Vp and the bottom value Vb is reset in response to the rise time and fall time of the output signal.

Then, as indicated in the condition II, in the case where the rotating body stops rotating and the detection signal drifts when the rotating body stop rotating, the sensor signal processing device 1 executes the offset adjustment of the detection signal. The offset adjustment is executed as follows. The output signal, the upper amplitude value A, the lower amplitude value B and the count result of the number of pulses by the counter 22 are transmitted to the determination portion 14. In the case where the determination portion 14 determines that the sensor signal processing device 1 stably operates because the number of pulses is plenty (e.g. the number of pulses is equal to or more than ten), the determination portion 14 sets the constant value C, used for the determination, to be lower (e.g. 20 mV). Then, the determination portion 14 sets the upper amplitude value A, which is currently held, as the reference value because the output signal is in the High level.

In this state, the determination portion 14 determines whether or not the lower amplitude value B is greater than the set value, which is defined on the basis of the upper amplitude value A (i.e. upper amplitude value A+constant value C). In other words, the determination portion 14 determines whether or not the relationship “lower amplitude value B>upper amplitude value A+constant value C” is satisfied. Then, the determination portion 14 sends the determination result to the offset adjustment signal generating portion 11.

In the case where the determination result, which indicates that the relationship “upper amplitude value A>lower amplitude value B+constant value C” is satisfied, is transmitted to the offset adjustment signal generating portion 11 from the determination portion 14, the offset adjustment signal generating portion 11 outputs the offset adjustment signal for offset-adjusting the detection signal to the first estimating portion 10. The first estimating portion 10 offsets the detection signal by the predetermined amount on the basis of the offset adjustment signal in order to decrease the lower amplitude value B.

When the rotating body restarts rotating in the state where the detection signal is offset (i.e. when the condition turns to the condition III), the threshold value estimating portion 21 estimates the threshold value Vth on the basis of the peak value Vp, corresponding to the upper amplitude value A to which the offset adjustment is not executed, and the bottom value Vb, corresponding to the lower amplitude value B which has been decreased by the offset adjustment. Then, the detection signal is binarized by the second estimating portion 17 on the basis of the threshold value Vth, and the second estimating portion 17 outputs the normal pulse signal as the output signal. Accordingly, the sensor signal processing device 1 outputs the proper output signal while preventing a pulse skipping from occurring even in the case where the detection signal drifts.

In the above-described embodiment, the condition I indicates the state where the sensor signal processing device 1 is in the stably operated state in which the certain time has passed since the sensor signal processing device 1 has started. The offset adjustment in the case where the sensor signal processing device 1 has just started will be described below with reference to FIG. 7. In FIG. 7, a lateral axis represents time line. More specifically, time is indicated so as to flow from left to right in FIG. 7. In FIG. 7, a condition I indicates a state where the sensor signal processing device 1 has just started, a condition II indicates a state where the offset adjustment is being executed in the case where the detection signal drifts towards the upper side over the range median value Mr, and a condition III indicates a state where the offset adjustment is being executed in the case where the detection signal drifts towards the lower side below the range median value Mr.

In the condition I, the rotating body starts rotating and the output signal is normally outputted as the pulse output on the basis of the detection signal and the threshold value Vth, which is estimated from the detection signal. In a case where the detection signal drifts in this condition, the offset adjustment is executed as follows. The output signal, the upper amplitude value A, the lower amplitude value B and the count result of the number of pulses by the counter 22 are transmitted to the determination portion 14. The number of pulses being few (e.g. the number of pulses being less than ten) indicates that the sensor signal processing device 1 has just started. Hence, in this case, the determination portion 14 sets the constant value C, which is used for the determination, to be a greater value (e.g. 80 mV). The constant value C is set to be a greater value because the sensor signal processing device 1 has just started and the accurate detection signal may not have been obtained. If a lower value (e.g. approximately 20 mV) is used as the constant value C even if the sensor signal processing device 1 has just started, unnecessary offset adjustment may be executed. Hence, in this embodiment, the constant value C is set to be a greater value in the case where the sensor signal processing device 1 has just started in order to prevent unnecessary offset adjustment from being executed.

The determination portion 14 sets the lower amplitude value B, which is currently held, as the reference value because the output signal is in the Low level. In this state, the determination portion 14 determines whether or not the upper amplitude value A is greater than the set value, which is defined on the basis of the lower amplitude value B (lower amplitude value B+constant value C). In other words, the determination portion 14 determines whether or not the relationship “upper amplitude value A>lower amplitude value B+constant value C” is satisfied. Then, the determination portion 14 transmits the determination result to the offset adjustment signal generating portion 11.

In the case where the determination result, which indicates that the relationship “upper amplitude value A>lower amplitude value B+constant value C” is satisfied, is transmitted to the offset adjustment signal generating portion 11 from the determination portion 14, the offset adjustment signal generating portion 11 outputs the offset adjustment signal for offset-adjusting the detection signal to the first estimating portion 10. The first estimating portion 10 offsets the detection signal by the predetermined amount on the basis of the offset adjustment signal in order to decrease the upper amplitude value A. Accordingly, the output signal, which is estimated on the basis of the detection signal, to which the offset adjustment is executed, and the threshold value Vth, which is estimated on the basis of the detection signal, is outputted.

In a case where the time has passed in the above-mentioned state (i.e. the condition turns to the condition II) and the detection signal further drifts, the offset adjustment is executed as follows. In the case where the determination portion 14 determines that the sensor signal processing device 1 stably operates because the number of pulses is plenty (e.g. the number of pulses is equal to or more than ten), the determination portion 14 sets the constant value C, which is used for the determination, to be lower (e.g. 20 mV). Then, the determination portion 14 sets the lower amplitude value B, which is currently held, as the reference value because the output signal is in the Low level.

In this state, the determination portion 14 determines whether or not the upper amplitude value A is greater than the lower amplitude value B. In other words, the determination portion 14 determines whether or not the relationship “upper amplitude value A>lower amplitude value B+constant value C” is satisfied. Then, the determination portion 14 transmits the determination result to the offset adjustment signal generating portion 11. In the case where the determination result, which indicates that the relationship “upper amplitude value A>lower amplitude value B+constant value C” is satisfied, is transmitted to the offset adjustment signal generating portion 11 from the determination portion 14, the offset adjustment signal generating portion 11 outputs the offset adjustment signal for offset-adjusting the detection signal to the first estimating portion 10. The first estimating portion 10 offsets the detection signal by the predetermined amount on the basis of the offset adjustment signal in order to decrease the upper amplitude value A. Accordingly, the output signal, which is estimated by the second estimating portion 17 on the basis of the offset-adjusted detection signal and the threshold value Vth estimated from the detection signal, is outputted as the final output signal of the sensor signal processing device 1.

In a case where the time has passed in the above-mentioned state (i.e. the condition turns to the condition III) and the detection signal drifts, the offset adjustment is executed as follows. In the case where the determination portion 14 determines that the sensor signal processing device 1 stably operates because the number of pulses is sufficient (e.g. the number of pulses is equal to or more than ten), the determination portion 14 sets the constant value C, which is used for the determination, to be lower (e.g. 20 mV). Then, the determination portion 14 sets the upper amplitude value A, which is currently held, as the reference value because the output signal is in the High level.

In this state, the determination portion 14 determines whether or not the lower amplitude value B is greater than the set value, which is defined on the basis of the upper amplitude value A (i.e. upper amplitude value A+constant value C). In other words, the determination portion 14 determines whether or not the relationship “lower amplitude value B>upper amplitude value A+constant value C” is satisfied. Then, the determination portion 14 transmits the determination result to the offset adjustment signal generating portion 11. In the case where the determination result, which indicates that the relationship “lower amplitude value B>upper amplitude value A+constant value C” is satisfied, is transmitted to the offset adjustment signal generating portion 11 from the determination portion 14, the offset adjustment signal generating portion 11 outputs the offset adjustment signal for offset-adjusting the detection signal to the first estimating portion 10. The first estimating portion 10 offsets the detection signal by the predetermined amount on the basis of the offset adjustment signal in order to decrease the lower amplitude value B. Accordingly, the output signal, which is estimated by the second estimating portion 17 on the basis of the offset-adjusted detection signal and the threshold value Vth estimated from the offset-adjusted detection signal, is outputted as the output signal of the final sensor signal processing device 1. Accordingly, the sensor signal processing device 1 outputs the proper output signal while preventing the pulse skipping from occurring even in the case where the detection signal drifts.

### Other Embodiments

In the above-described embodiment, the lower amplitude value B is used as the reference value in the case where the output signal is in the Low level. On the other hand, the upper amplitude value A is used as the reference value in the case where the output signal is in the High level. However, the present invention is not limited to the above-described configuration. For example, the sensor signal processing device 1 may be modified so that the output signal of the first estimating portion 10 is inputted into the non-inverting terminal 17b of the second estimating portion 17 and so that the output (the threshold value Vth) of the threshold value estimating portion 21 is inputted into the inverting terminal 17a of the second estimating portion 17. In this case, use of the High level and the Low level of the output signal of the sensor signal processing device 1 in the above-described embodiment are reversed. Hence, the setting of the reference value is also preferably reversed. More specifically, in the modified sensor signal processing device 1, the upper amplitude value A is used as the reference value in the case where the output signal is in the Low level, and the lower amplitude value B is used as the reference value in the case where the output signal is in the High level.

In the above-described embodiment, the offset adjustment signal generating portion 11 generates the offset adjustment signal in the case where one of the upper amplitude value A and the lower amplitude value B is set as the reference value and the other one of the upper amplitude value A and the lower amplitude value B exceeds the set value, which is defined on the basis of the reference value. The constant value, which is used to define the set value, is determined in response to the number of pulses, which is included in the output signal and is counted by the counter 22. More specifically, in the above-described embodiment, the determination portion 14 determines that the sensor signal processing device 1 has just started in the case where the number of pulses of the output signal is less than ten. On the other hand, the determination portion 14 determines that the sensor signal processing device 1 is in the stably operated state in the case where the number of pulses of the output signal is equal to or more than ten. However, the present invention is not limited to the above-described configuration. The pulse number of ten (threshold) used for determining the condition of the sensor signal processing device 1 is only an example, and other threshold values (reference values) may be used.

In the above-described embodiment, the constant value C, which is used by the determination portion 14 for the determination, is set to 80 mV in the case where the sensor signal processing device 1 has just started. On the other hand, in the case where the sensor signal processing device 1 is in the stably operated state, the constant value C is set to 20 mV. However, the present invention is not limited to the above configuration, and it is understood that the constant value C may be set to other values. Even if the constant value C is set to other values, the sensor signal processing device 1 properly executes the offset adjustment and outputs the output signal.

In the above-described embodiment, the constant value C, which is used by the determination portion 14 for the determination, is preliminarily set in the manner where: the constant value C is set to 20 mV in the case where the sensor signal processing device 1 has just started, and the constant value C is set to 80 mV in the case where the sensor signal processing device 1 is in the stably operated state. However, the present invention is not limited to the above-described configuration. In the sensor signal processing device 1 of the above-described embodiment, the detection signal is converted into digital values by a predetermined resolution, as illustrated in FIG. 8 (FIG. 8A and FIG. 8B). Illustrated in FIG. 8B is the detection signal when drifting is enlarged. The resolution may be set as one step, and the constant value C may be determined on the basis of the number of steps. For example, in this case, the constant value C may be set as fifty steps in the case where the sensor signal processing device 1 has just started, and the constant value C may be set as two steps in the case where the sensor signal processing device 1 is in the stably operated state. The determination 14 may execute the determination on the basis of the constant value C, which is set as described above.

In the above-described embodiment, the detection signal, to which the sensor signal processing device 1 executes the offset adjustment, drifts due to the changes of the ambient temperature, i.e. the temperature drift occurs in the detection signal. However, the present invention is not limited to the above-described situation. For example, according to the sensor signal processing device 1, even if the detection signal fluctuates not only because of the temperature drift, but also because of other facts, the detection signal is offset-adjusted.

In the above-described embodiment, the offset amount for the offset adjustment of the detection signal executed by the sensor signal processing device 1 corresponds to the constant value C. However, the present invention is not limited to the above configuration. For example, the detection signal may be offset at most by the constant value C. More specifically, the sensor signal processing device 1 may be modified so that the detection signal is offset by an amount equal to or less than the constant value C (C−α>0). Further, for example, in a case where the upper amplitude A is greater than the set value (i.e. upper amplitude value A>lower amplitude value B+constant value C), it may be preferable that the waveform of the detection signal is offset-adjusted so as to be displaced towards the lower amplitude by C/2. In this case, the upper amplitude value A decreases by C/2 and the lower amplitude value B increases by C/2, so that the upper amplitude value A and the lower amplitude value B are equalized.

According to the embodiments, in the case where the offset adjustment is determined to be unnecessary, the detection signal is outputted as the output signal of the first estimating portion 10 without being offset-adjusted.

According to the embodiments, in the case where the peak value Vp of the detection signal is updated every predetermined time, an amplitude value of when an amplitude at an upper side over the median value Mr of the range Wr in the predetermined time reaches a peak is set as the upper amplitude value A.

According to the embodiments, in the case where the bottom value Vb of the detection signal is updated every predetermined time, an amplitude value of when an amplitude at a lower side below the median value Mr of the range Wr in the predetermined time reaches a bottom peak is set as the lower amplitude value B.

According to the embodiments, the sensor signal processing device 1 includes the counter 22 for counting the number of pulses included in the binarized output signal. The set value is set in a manner where, in the case where the number of pulses becomes equal to or more than the predetermined number of pulses, the set value is set to be lower than a set value of when the number of pulses is less than the predetermined number of pulses.

According to the embodiments, the sensor signal processing device 1 includes the peak reset portion 12 and the peak hold portion 18, which estimates the peak value Vp. In the case where the binarized output signal falls, the peak reset portion 12 resets the peak value Vp estimated by the peak hold portion 18 and the peak hold portion 18 re-estimates the peak value Vp.

According to the embodiments, the sensor signal processing device 1 includes the bottom reset portion 13 and the bottom hold portion 19, which estimates the bottom value Vb. In the case where the binarized output signal rises, the bottom reset portion 13 resets the bottom value Vb estimated by the bottom hold portion 19 and the bottom hold portion 19 re-estimates the bottom value Vb.

According to the embodiments, the lower amplitude value B is used as the reference value in the case where the binarized output signal is in the Low level. On the other hand, the upper amplitude value A is used as the reference value in a case where the binarized output signal is in the High level.

According to the embodiments, the set value is defined by the sum of the lower amplitude value B and the constant value C in the case where the output signal is in the Low level. On the other hand, the set value is defined by the sum of the upper amplitude value A and the constant value C in the case where the output signal is in the High level.

According to the embodiments, in the case where the upper amplitude value A is greater than the set value, defined on the basis of the lower amplitude value B, when the output signal is in the Low level, the offset adjustment signal generating portion 11 outputs the offset adjustment signal, which reduces the upper amplitude value A by the constant value C, to the first estimating portion 10. On the other hand, in the case where the upper amplitude value A is not greater than the set value, defined on the basis of the lower amplitude value B, the offset adjustment signal for offset-adjusting the detection signal is not outputted.

According to the embodiments, in the case where the lower amplitude value B is greater than the set value, defined on the basis of the upper amplitude value A, when the output signal is in the High level, the offset adjustment signal generating portion 11 outputs the offset adjustment signal, which reduces the lower amplitude value B by the constant value C, to the first estimating portion 10. On the other hand, in the case where the lower amplitude value B is not greater than the set value, defined on the basis of the upper amplitude value A, the offset adjustment signal for offset-adjusting the detection signal is not outputted.

Accordingly, even if the detection signal, which is outputted from the rotation detection device 2, drifts due to the changes of the ambient temperature and the like, the pulse skipping in the binarized output signal is surely prevented from occurring because the offset adjustment is executed on the basis of the reference value, which is set on the basis of the output signal, and the set value, which is defined by the reference value.

Accordingly, unnecessary offset adjustment is prevented from being executed in the case where the detection signal is not stabilized.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A signal processing device for a sensing device, the signal processing device generating a binarized output signal on the basis of a detection signal inputted from the sensing device and a threshold value estimated from the detection signal, the signal processing device comprising:
an upper amplitude value estimating portion for estimating an upper amplitude value on the basis of a peak value of the detection signal and a predetermined median value of a preset range;
a lower amplitude value estimating portion for estimating a lower amplitude value on the basis of the median value and a bottom value of the detection signal;
an offset adjustment signal generating portion for generating an offset adjustment signal for executing an offset adjustment of the detection signal in a case where either one of the upper amplitude value or the lower amplitude value is set as a reference value in response to the output signal and the other one of the upper amplitude value and the lower amplitude value becomes greater than a set value defined on the basis of the reference value;
an offset adjustment portion for offset-adjusting the detection signal on the basis of the offset adjustment signal inputted from the offset adjustment signal generating portion; and
a binarization portion for binarizing an output signal from the offset adjustment portion on the basis of the threshold value estimated from the detection signal.

2. The signal processing device for the sensing device according to claim 1, wherein in a case where the offset adjustment is determined to be unnecessary, the detection signal is outputted as the output signal of the offset adjustment portion without being offset-adjusted.

3. The signal processing device for the sensing device according to claim 1, wherein in a case where the peak value of the detection signal is updated every predetermined time, an amplitude value of when an amplitude at an upper side over the median value of the range in the predetermined time reaches a peak is set as the upper amplitude value.

4. The signal processing device for the sensing device according to claim 1, wherein in a case where the bottom value of the detection signal is updated every predetermined time, an amplitude value of when an amplitude at a lower side below the median value of the range in the predetermined time reaches a bottom peak is set as the lower amplitude value.

5. The signal processing device for the sensing device according to claim 1 further comprising a counter for counting a number of pulses included in the binarized output signal, wherein the set value is set in a manner where, in a case where the number of pulses becomes equal to or more than a predetermined number of pulses, the set value is set to be lower than a set value of when the number of pulses is less than the predetermined number of pulses.

6. The signal processing device for the sensing device according to claim 1 further comprising a peak reset portion and a peak hold portion for estimating the peak value, wherein, in a case where the binarized output signal falls, the peak reset portion resets the peak value estimated by the peak hold portion and the peak hold portion re-estimates the peak value.

7. The signal processing device for the sensing device according to claim 1, further comprising a bottom reset portion and a bottom hold portion for estimating the bottom value, wherein in a case where the binarized output signal rises, the bottom reset portion resets the bottom value estimated by the bottom hold portion and the bottom hold portion re-estimates the bottom value.

8. The signal processing device for the sensing device according to claim 1, wherein the lower amplitude value is used as the reference value in a case where the binarized output signal is in a Low level, and wherein the upper amplitude value is used as the reference value in a case where the binarized output signal is in a High level.

9. The signal processing device for the sensing device according to claim 8 further comprising a counter for counting a number of pulses included in the binarized output signal, wherein the set value is set in a manner where, in a case where the number of pulses becomes equal to or more than a predetermined number of pulses, the set value is set to be lower than a set value of when the number of pulses is less than the predetermined number of pulses.

10. The signal processing device for the sensing device according to claim 8, wherein the set value is defined by a sum of the lower amplitude value and a constant value in the case where the output signal is in the Low level, and wherein the set value is defined by a sum of the upper amplitude value and the constant value in the case where the output signal is in the High level.

11. The signal processing device for the sensing device according to claim 10, wherein in a case where the upper amplitude value is greater than the set value, defined on the basis of the lower amplitude value, when the output signal is in the Low level, the offset adjustment signal generating portion outputs the offset adjustment signal, which reduces the upper amplitude value by the constant value, to the offset adjustment means, and wherein, in a case where the upper amplitude value is not greater than the set value, defined on the basis of the lower amplitude value, the offset adjustment signal for offset-adjusting the detection signal is not outputted.

12. The signal processing device for the sensing device according to claim 10, in a case where the lower amplitude value is greater than the set value, defined on the basis of the upper amplitude value, when the output signal is in the High level, the offset adjustment signal generating portion outputs the offset adjustment signal, which reduces the lower amplitude value by the constant value, to the offset adjustment means, and wherein, in a case where the lower amplitude value is not greater than the set value, defined on the basis of the upper amplitude value, the offset adjustment signal for offset-adjusting the detection signal is not outputted.
